(19) United States
(12) Patent Application Publication
(10) Pub. No.: US 2001/0056401 A1
(43) Pub. Date: Dec. 27, 2001

(54) Integrated system for providing financial services including internet TV capabilities

(76) Inventor: Peter Tompkins, Malibu, CA (US)

Correspondence Address: George T. Marcou, Esq., Kilpatrick Stockton LLP, Suite 800, 700 13th Street, NW, Washington, DC, 20005, US

(21) Appl. No.: 09/775,259

(22) Filed: Feb. 1, 2001

Related U.S. Application Data
(60) Provisional application No. 60/179,963, filed on Feb. 3, 2000.

(51) Int. Cl. G06F 17/60

(52) U.S. Cl. 705/42

(57) ABSTRACT

The methods and systems of the present invention allow for the integration of different electronic commerce (“e-commerce”) and electronic banking (“e-banking”) technologies to advantageously provide an increased level of services to banking customers including consumers and merchants. A particular feature of the present invention is the integration of a television interface with e-commerce, home banking and credit/debit card processing services and internet technologies to provide a single conduit for merchants and consumers to financial services networks.

### STATEMENT OF RELATED APPLICATIONS

The present application claims priority under 35 USC 119(e) from U.S. provisional application Ser. No. 60/179,963, filed Feb. 3, 2000, entitled “Method and System for Providing Banking Services”.

### FIELD OF THE INVENTION

The present invention generally relates to the field of electronic commerce and banking services. The methods and systems of the present invention allow for the integration of different electronic commerce (“e-commerce”) and electronic banking (“e-banking”) technologies to advantageously provide an increased level of services to banking customers including consumers and merchants. A particular feature of the present invention is the integration of a television interface with e-commerce, home banking and credit/debit card processing services and internet technologies to provide a single conduit for merchants and consumers to financial services networks.

### BACKGROUND OF THE INVENTION

The availability and number of e-banking and e-commerce services available to consumers continues to grow.

Methods and systems exist for providing bill presentment and payment services. The use of technology for electronic bill presentment and payment can reduce the cost of the billing and payment process for up to 100 million US households and their vendors and service providers. Among the most advantageous methods are those described in commonly assigned U.S. patent application Ser. No. 09/137,812, filed Aug. 21, 1998 entitled “A Method And System For Presentment And Payment” the disclosure of which is hereby incorporated herein by reference.

Electronic banking (e-banking) is often also referred to as home banking. Home banking can be a large and profitable source, for example, of new customers for a financial institution, such as a bank. A home services delivery system (HSDS) provides multi-function financial services, such as account information, transfers, customer service, payment, payee lists, direct debit, and mutual funds, to a user accessible through a personal computer (PC) or an interface appliance like an internet TV.

The field of e-commerce is rapidly expanding as increasing numbers of goods and services are made available for purchase over the internet. Methods and systems for providing e-commerce banking services, such as merchant services for credit/debit cards and money transfer services between a consumer and a merchant's bank currently exist. Among the most advantageous of these systems are those described in the commonly assigned US patent applications: serial number not yet assigned, filed Aug. 26, 1999 entitled “System And Method For Merchant Function Assumption Of Internet Checking And Savings Account Transactions”; Ser. No. 09/237,739 filed Jan. 26, 1999 entitled “System and Method for Accessing Banking Account Funds For Internet Transaction”; and, serial number not yet assigned, filed Aug. 27, 1999, entitled “System and Use for Correspondent Banking”. The disclosures of each of these applications are hereby incorporated herein by reference.

Applications and systems have also been developed for using cellular phones and related telecommunication networks for providing banking services. A particularly advantageous system is described in commonly assigned U.S. patent application Ser. No. 09/344,685, filed Jun. 25, 1999, entitled “Method And System For Providing Financial Services Such As Home Banking”. The disclosure of this application is also incorporated herein by reference. It would be advantageous to have integrated systems, such as those contemplated by the present invention, that provide for the use of cellular phone systems.

Although methods and systems exist for providing e-commerce and e-banking services to consumers, there exists a need for an integrated system that will integrate the functionality of prior systems and provide for enhanced functionality between financial services companies, merchants and consumers.

### SUMMARY OF THE INVENTION

The present invention provides systems and methods for providing financial services to consumers and merchants that integrate existing systems into an overall systems that combines the functionality of the existing systems. In a first aspect, the present invention integrates e-commerce, home banking and credit/debit card services to allow consumers and merchants a single source, and thus a connection to a single network for multiple services that have traditionally required multiple sources and routing to multiple networks. The integrated services may be included in a system comprising a television interface as a user interface.

A feature and advantage of the present invention is an electronic clearinghouse for providing e-commerce services to merchants and consumers. The electronic clearinghouse may provide merchant services for credit/debit cards and/or route electronic payment transactions to a merchant's bank.

Another feature and advantage of the present invention is electronic bill presentment for merchants and electronic bill payment for consumers.

A further feature and advantage of the present invention is e-banking or home-banking services for consumers.

These features and advantages are achieved by the systems of the present invention.

According to the present invention a system architecture for providing financial services to consumers comprises:

a consumer interface and at least one of the following systems:

a financial accounts system;

a bill presentment and payment system; and/or

a credit/debit card clearance system.

The consumer interface may comprise a central processing unit and a display unit. In an embodiment of the present invention, the display unit also functions as a conventional television for receiving cable, satellite and/or broadcast television signals. The central processing unit (cpu) includes hardware and software to allow the cpu to interface with the display unit and the servers described below.

A feature of an embodiment of the present invention is a television interface. “Internet television” or “iTV” is utilized herein to refer to an information appliance which provides the functionality of a personal computer, internet access via cable or direct telecommunications link, the entertainment aspects of a traditional television in a combination that permits interaction between the component parts. For example, an iTV may allow a user to interact with a broadcast companies' web site while watching a TV show. An advantageous embodiment of an iTV, which includes additional home theater and audio functionality is described in the commonly assigned U.S. patent application Ser. No. 9/267,300, filed Mar. 15, 1999 entitled “Method And System Of User Interface For A Computer” the disclosure of which is hereby incorporated herein by reference.

In an embodiment of the present invention, the iTV user interface comprises a full function computer including a home theater, entertainment, education and information, and home banking environment which is designed to optimize for television display. To achieve the stated and other features, advantages and objects of the present invention, an embodiment of the invention provides a method and system of user interface for a computer which automatically displays a screen for a control center application folder that represents a plurality of bundled applications for the computer upon receiving a selection for the control center application folder. The system receives a selection for at least one of the applications represented by the control center application folder and automatically displays a screen for a plurality of functions for the selected application. Upon receiving a selection for at least one of the application functions, the system automatically implements the application function. The selection of the screen for the control center application folder is made from a menu screen which automatically displays a plurality of folders for the computer system, including the control center application folder. The process of receiving all selection involves a user entering the selection at the computer in response to an automatic prompt by the system. The screen that is displayed for the control center application folder is one of a plurality of such screens. The user can enter a selection for one of the alternate screens, and upon receiving the selection of an alternate screen, the system automatically displays an alternate screen for the control center application folder.

The bill presentment and bill payment system interacts with the consumer interface to provide bill presentment and payment services. Bill presentment according to the present invention is an enhancement to electronic bill payment that adds considerable value to the customer proposition and allows a tracking capability for bills received and paid. It also allows customers to store bills electronically and manipulate them, which has not been previously possible. Electronic bill payment is done between consumers and their banks or other service providers, but electronic bill presentment involves the biller and its service provider as well, so the bill presentment and payment system feature of the present invention involves more entities, namely consumers, businesses and networks. The systems and operational flows of the present invention are designed to meet the needs of both consumers and billers.

The bill presentment and payment system feature of the present invention is designed to accommodate all the possible entities currently involved in the bill presentment and payment process, and to add value to all parties over the current system. The system of the present invention streamlines the entire process, reduces the delay, cost and manual processing involved, and also provides increased control and better access to information for all the parties. The system of the present invention also provides the ability to deal with special handling of bills, including priority handling, automatic filing into folders, and filters to screen unwanted messages. The system of the present invention further enables billers and consumers to consolidate bills and bill presentment. The system of the present invention additionally allows billers to personally customize and control the content and format of the bill presentment within the constraints of the presentation device selected by the consumer, including the ability to include graphics, to sort the information in any arbitrary order, to subtotal, and to insert enclosures.

The electronic bill presentment and payment system of the present invention may enable one-stop retrieval and payment of bills by consumers and provides consumers with greater control over their financial data by providing a centralized financial information repository on a mailbox server. The system of the present invention also provides billers with efficiency by enabling access to consumers from a number of financial institutions, including banks; provides billers with control over bill presentation and links between payment and invoice; and provides billers with faster and lower cost bill presentment. Further, the bill presentment and payment system of the present invention provides bill and consumer service providers with a standard interface that simplifies integration with existing financial institution, bill and consumer service provider systems.

The credit and debit system of the present invention may comprise systems known in the art and described in the above-referenced applications that allow financial services institutions to manage and handle credit transactions. According to the present invention, credit and bill processing may occur within the financial institution that is operating the integrated systems of the present invention, or the integrated systems may allow routing of credit and bill processing transactions to other financial institutions.

In a featured embodiment of the present invention, credit and debit transaction processing occurs through the same network as e-commerce and e-banking transactions. Thus, a merchant and consumers are provided with a single set of protocols and a single advantageous source to serve their e-commerce and banking needs.

An embodiment of the present invention includes a merchant processing front end for handling credit/debit card transactions. A system of the present invention provides means for processing credit/debit transactions wherein the financial services institution operating an integrated system is the credit card issuing institution, and wherein another institution is the credit card issuing institution. When the operator of the integrated system is also the credit card issuing institution, transaction information is routed to an appropriate internal server. When the operator of the integrated system is not the credit card issuing institution, the transaction information is routed to the issuing institution. However, in each case, the merchant and consumer are provided with a uniform front end provided by a system of the present invention.

Another aspect of the present invention is the integration of a cellular telephone and related telecommunication system with a home banking system. To achieve the stated objects, advantages and novel features of the present invention, an embodiment of the invention provides a method and system of performing a transaction for a user at a remote terminal, which makes use, for example, of a server, such as a financial institution-controlled banking application server, and a wireless communication link between the server and the remote terminal. The remote terminal includes, for example, a wireless communication device, such as a wireless cell phone device, coupled to, for example, an HTML renderer, which in turn is coupled, for example, to a television set in the user's home. The HTML renderer can be housed in a set top box (STB), or the HTML renderer and the wireless communication device can be housed together in a stand-alone STB, or they can be incorporated in the television set or other display device. Further, the wireless communication device can be a standard cell phone. The remote terminal also includes, for example, an input device for the user linked to the wireless communication device, such as a keyboard, an infrared (IR)-driven keyboard, a mouse, an IR driven mouse, or the number pad of a standard cell phone.

In an embodiment of the present invention, a wireless communication link for transmitting data is established between the remote terminal and the server using a wireless communication facility, such as a cell phone transmission facility, which is coupled to the server. The cell phone transmission facility can be a second generation Global System for Mobile communication (GSM) cell phone transmission facility using, for example, Wireless Internet Protocol (IP), and preferably, the cell phone transmission facility can be a third generation GSM (or successor to third generation GSM) cell phone transmission facility using, for example, Wireless IP which is preferably connectionless. Alternatively, the data can be transmitted between the server and the remote terminal using a satellite system, such as a Low Earth Orbiting (LEO) satellite system or a GeoStationary satellite system, or a Wireless Local Loop (WiLL) system. The user can be authenticated at the remote terminal using, for example, a digital certificate on an application on the microprocessor of a smart card of the user. For this purpose, a smart card reader can be coupled to the wireless communication device of the remote terminal.

In an embodiment of the present invention, data is transmitted between the server and the remote terminal via the wireless communication facility. Data, for example, for a home banking transaction is transmitted from the banking application on the server to the remote terminal and received by the wireless communication device, which automatically sends the data to the HTML renderer. In turn, the HTML renderer automatically renders, for example, a user interface display for a banking transaction on the television set in a format, such as Phase Alternating Line (PAL) screen format, for the user. In response, for example, to prompts by the user interface display, the user enters information for a user transaction. The user enters the information using, for example, the input device of the remote terminal. The entered information is sent to the server by the wireless communication device of the remote terminal via the wireless communication facility coupled to the server. Thus, the user at the remote terminal interacts, for example, with the banking application on the server to perform a transaction, such as a home banking transaction.

In another aspect, the present invention provides an enabling product that facilitates implementation of an e-commerce and/or e-banking business solution in a system comprising a television interface. A typical e-commerce offering, according to an embodiment of the present invention, includes a merchant site (eMall) providing a product, good or service to be purchased, a payment system allowing online authorization of funds to purchase the goods and a wireless network for all customer interactions. The payment system may comprise a credit card processing system or a bank account debiting system. A typical e-banking system includes a financial institution, one or more customer accounts, and may further include bill presentment and payment capabilities.

An embodiment of an enabling product of the present invention comprises three components: 1) a protocol conversion; 2) a customer information repository, and 3) a payment gateway interface. The protocol conversion aspect of the present invention, according to an embodiment, converts content developed in HTML, Compact HTML (CHTML or I-Mode), or XML to Wireless Markup Language (WML), HDML (UP Browser), CHTML or XML. The protocol conversion may further convert content, data and/or input from an iTV interface device into a form that may be utilized by a financial services industry network.

The customer information repository, according to an embodiment of the present invention, contains various customer personal information such as a financial services account information, a list of credit cards or payment vehicles that may be used for a purchase transaction and the like. The payment gateway interface aspect of the present invention, according to one embodiment, provides interface logic with a payment gateway to facilitate the authorization of a commerce transaction.

An advantage of the present invention is that a system of the present invention integrates iTV technologies with a financial services network to facilitate business to consumer e-commerce, home banking, bill presentment and similar services.

Additional details and advantages of the present invention will become apparent from the following more detailed description.

### BRIEF DESCRIPTION OF THE FIGURES

FIG. 1 depicts a possible embodiment of a general architecture for a system of the present invention.

FIG. 2 depicts a possible embodiment of the front end of a system of the present invention.

FIG. 3 depicts a possible embodiment of a general architecture of a system of the present invention comprising a cable TV hook-up.

FIG. 4 depicts a credit card authorization function in an embodiment of a system of the present invention.

### DETAILED DESCRIPTION OF THE INVENTION

As will be realized from the description contained herein, there are many possible embodiments of a system and/or a method of the present invention.

In an embodiment, a system for providing financial services and facilitating transactions among a user, a merchant and a financial institution comprises

a user interface and at least one of the following financial services industry systems:

an interactive bill presentment and payment system accessible through the user interface;

a merchant payment processing system administered by the financial institution;

a credit and debit system administered by the financial institution;

a home-banking system;

a processor for receiving data from the user interface and translating the data into a form usable by at least one of the interactive bill presentment and payment system; the merchant payment processing system; the multi-function financial services system and/or the credit and debit system;

wherein the user interface comprises a television.

In an embodiment of the present invention, a method for providing financial services and facilitating transactions among a user, a merchant and a financial institution comprises:

providing a user interface that allows a user to access and at least one of the following financial services industry systems:

an interactive bill presentment and payment system accessible through the user interface;

a merchant payment processing system administered by the financial institution;

a credit and debit system administered by the financial institution;

a home-banking system;

providing a processor for receiving data from the user interface and translating the data into a form usable by at least one of the interactive bill presentment and payment system; the merchant payment processing system; the multi-function financial services system and/or the credit and debit system;

wherein the user interface comprises a television.

In embodiments of the present invention, the user interface may further comprise a control unit, or similar computer hardware, linked to the television. The control unit may further comprise one or more input means, including, but not limited to, a keyboard, a track pad, a mouse and/or a track ball. In embodiments of the present invention, the control unit may comprise a processor and memory. The memory may be random access memory (RAM) or read only memory (ROM), for example a ROM chip. The memory may comprise program routines necessary to control television viewing and/or establish a connection to the processing unit for implementing an aforementioned financial function. In a possible embodiment of the present invention, a single piece of computer hardware may function as both the processor and the control unit.

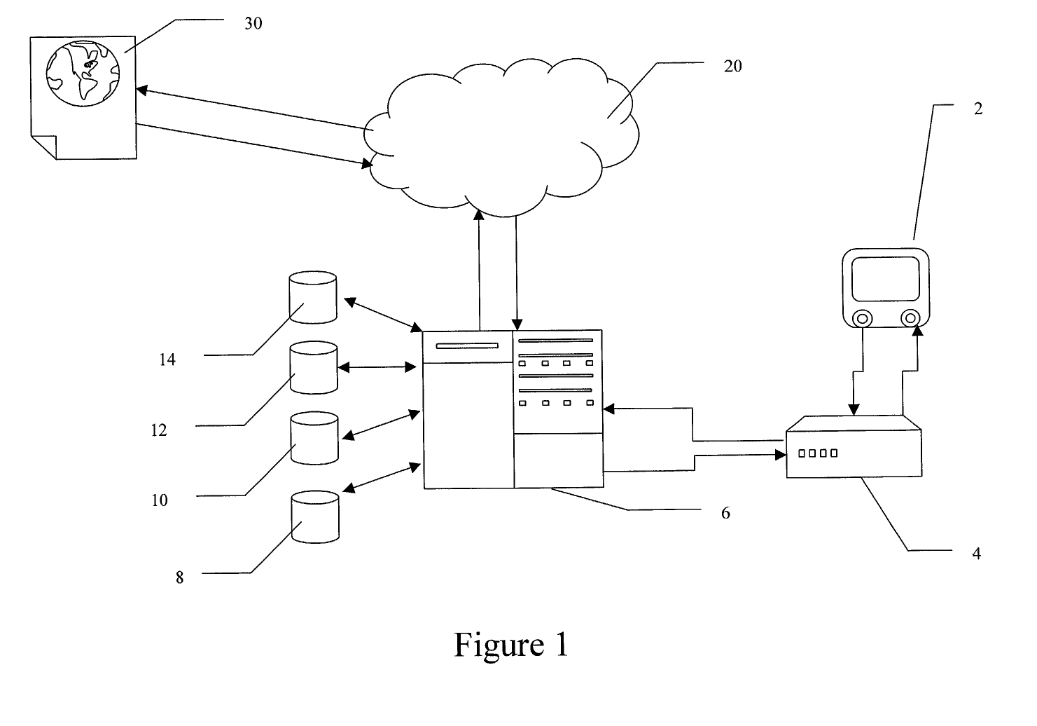

FIG. 1 provides a schematic depiction of a possible embodiment of a general architecture for a system of the present invention. As shown in FIG. 1, a system of the present invention includes a television, 2, connected to a processor 4. The processor may be located in the same environment as the television, for example, at a home. Alternatively, the processor may be located at a remote site, for example, at a cable television transmission point, or similar point. The term “processor” is utilized herein in a generic fashion to include personal computers with microprocessors, servers and minicomputers with processors and mainframe computers. The functions of the processor may be implemented in computer hardware or computer software. Processor 4 communicates with financial services institution server, 6. The financial services institution server 6 includes an interactive bill presentment and payment system 8, a credit and debit system, 10, and/or a home-banking system 12.

As further depicted on FIG. 1, an embodiment of a system of the present invention may allow access to the internet, 20. A user of the system may access a merchant, 30, through the internet and world wide web. Financial services institution server 6 may include a merchant payment processing system 14 to facilitate e-commerce between merchant (merchant server) 30 and a user of the system. Financial services institution server 6 communicates with merchant server 30 and upon initiation of a transaction, may further communicate with a payment processor such as credit and debit system 10.

A user communicates through a secure connection to a merchant's server 30, for example through an internet connection. Server 6 and processor 4 are also linked to the secure connection to enable communication among the merchant's server 30, the processor 4 and server 6 and systems 10, 12 and 14.

As set forth above, processor 4, may be located near the television set 2, or remotely. Processor 4, may comprise memory and software applications for interfacing with a user, iTV applications, and templates and screen rendering applications for banking functions. Alternatively, such functionality may be provided by financial services institution server 6.

The connections among the television set 2, the processor 4, the financial services institution server 6, the internet and/or the merchant 30, may comprise conventional technology for connecting computers and transmitting data, including, but not limited to TCP/IP technology, fiber optic cables, ADSL lines and the like. The transmissions among the components are preferably treated as secure transmissions, thus encryption or other security functionality may be incorporated into the system.

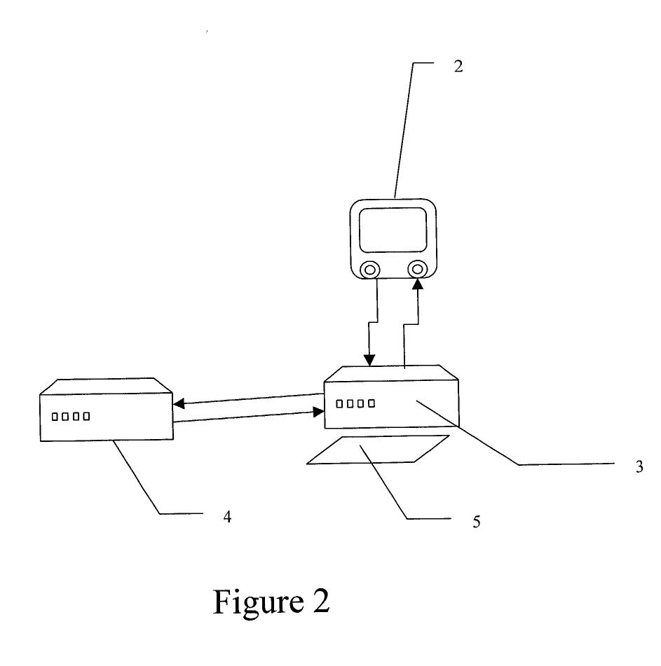

As shown in FIG. 2, alternative embodiments of the present invention may additionally comprise a so-called “set top system” or similar computer hardware 3, between processor 4 and television set 2. The set top system will generally include a central processing unit but need not include significant memory as templates and applications may be stored and run through processor 4. The set top system may comprise one or more input devices, such as a keyboard, remote, mouse or trackball etc. A keyboard with trackball, 5 is shown in FIG. 2.

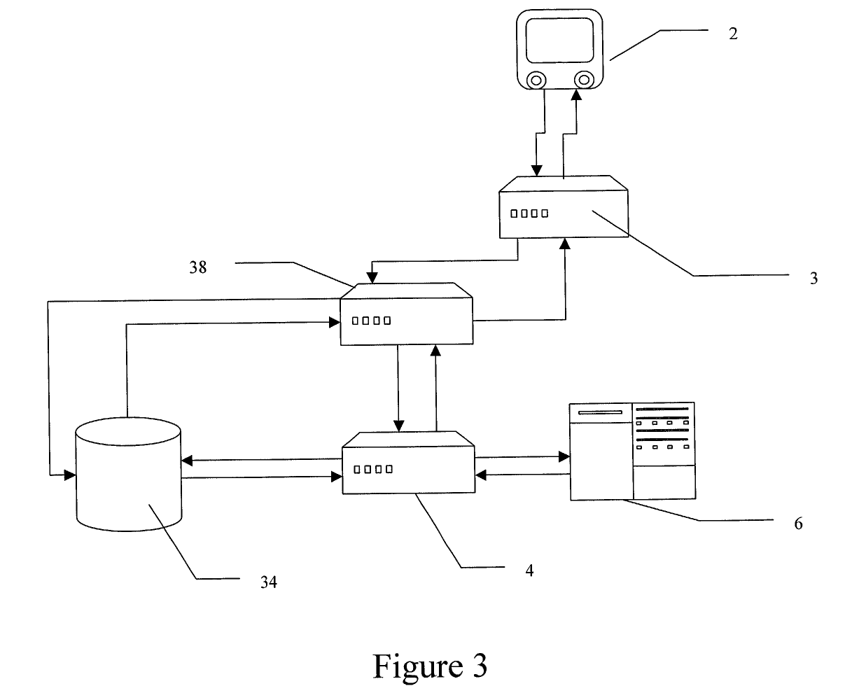

FIG. 3 depicts a possible embodiment of a system of the present invention wherein the connection among the financial services institution server 6, processor 4 and a set top system 3 and television 2, is made via a 2-way cable system. In this embodiment, the templates and screens for rendering applications for banking functions may be maintained on server 34 of a cable system 36 in communication with processor 4 that also may be maintained by the cable operator. The cable system will generally further include a cable combiner 38 in order to provide standard cable television services through the connection to the set top system .

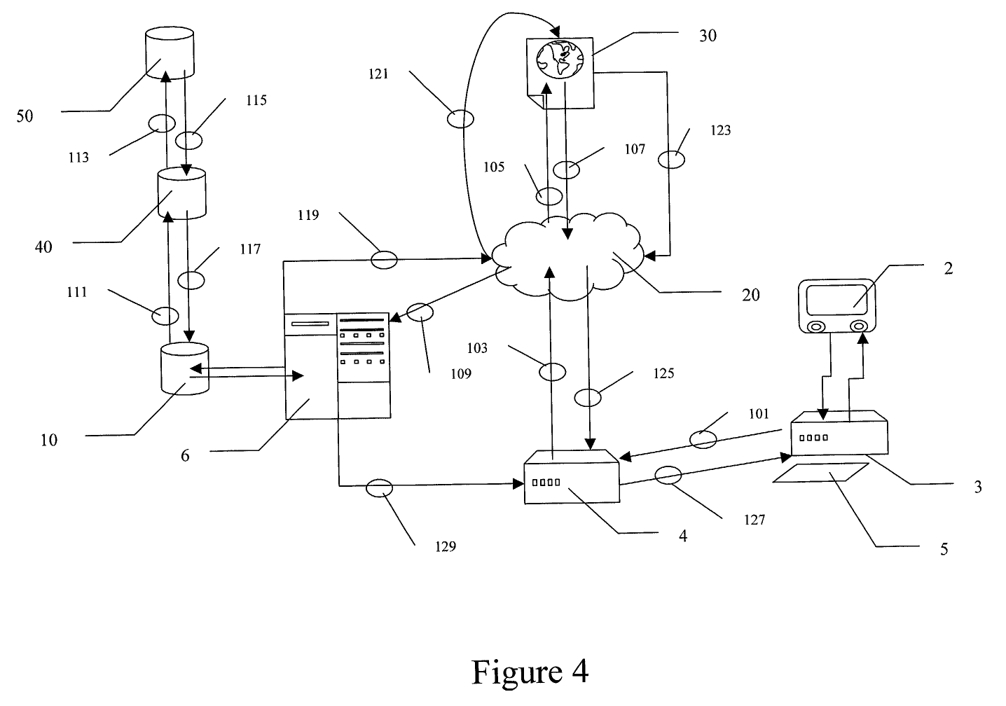

FIG. 4 depicts data flow in an embodiment of the present invention during a credit card authorization transaction in an e-commerce setting. Utilizing TV, 2 and set top system 3, a user interacts, through processor 4 and the internet 20, with merchant and merchant server 30, through communication links 101, 103 and 105. User selects a good and requests the merchant charge the user's credit card. Merchant server 30 communicates through internet 20, and communication links 107 and 109, with financial services institution server 6 that acts as the processor for the transaction through credit and debit processing system 10. The credit and debit processing system routes the transaction details, through communication link 111, to the sponsoring credit card association server 40, utilizing a financial services industry network. Association server 40 transmits an authorization request, through communication link 113, to an issuing bank server 50. The issuing bank server authorizes or denies the transaction and communicates the results, through communication link 115 back to association server 40. The information is next passed, through communication link 117, to credit and debiting processing system 10 of server 6. Merchant 30 is notified through communication links 119 and 121, and then the user is notified that the transaction has been approved or denied through the processor utilizing communication links 123, 125 and 127. Alternatively, in an embodiment of the present invention, processor the transaction approval/denial details are communication directly to processor 4 by financial services institution server 6, and communication link 129. Details relating to the type of information transmitted and the approval or denial process are set forth in the applications referenced above. The reference to communication links in the foregoing description is provided to illustrate the flow of data between servers. A single physical, or wireless, 2-way communication link may exist among the various servers. Further, as will be understood by those of ordinary skill in the art, the issuing bank may be the same or different from the financial institution providing the processing services.

As will be understood by those of ordinary skill in the art, the transaction depicted in FIG. 4 is representative of the types of transactions that may be undertaken in a system of the present invention. Additional transactions include those referred to above.

A role of processor 4 in a system of the present invention is to provide a uniform gateway between set top box 3 and/or iTV 2 and the financial services institution server 6. Thus, process 4 may translate code from the set top box into protocols that may be utilized by server 6 and attendant subsystems 8, 10, 12 and 14. As such, the services of processor 4 may be useful to cable television operators seeking to offer interactive banking services to their users.

Thus, in another the present invention provides an enabling platform to allow home banking and e-commerce through television services. The enabling platform may comprise one or more of the following three components: 1) a protocol converter, 2) a customer information repository, and 3) a payment gateway interface.

The protocol converter, which may be implemented in the processor described above, re-purposes existing content for different types of televisions and set top box devices and enables content providers to deliver a single marked up content to a wide range of devices. In essence the protocol converter converts web-site content and financial transaction data to a specific device message format. The protocol converter converts, by way of non-limiting example, content developed in HTML, Compact HTML (CHTML or I-Mode), or XML to a form that may be interactively displayed and accessed utilizing a set top box, television and/or iTV. Any source content can be converted. The protocol converter feature of the processor also ensures that existing source HTML content first be modified to support the financial services industry specifications, for example e-CITI XML, before being converted to a language understandable by the rendering device.

A customer information repository may be provided as part of the processor functionality in order to minimize the amount of input that a consumer has to enter while conducting a transaction. Minimizing the amount of customer input increases the speed and simplicity of transactions, which is very much in keeping with the fundamental idea of e-commerce. In addition, input devices for television and iTV may not be equipped with a robust keypad interface. Therefore, it may be important to minimize the amount of information collected from a customer during a transaction. The information, including, but not limited to, a preferred shipping address, a list of credit cards or payment vehicles that may be used for a purchase transaction and a television service subscriber ID number, may be gathered during a service registration process. The information is linked to the customers account data, for example at the cable television service provides, so at a later time when the customer wishes to make a transaction, the system of the present invention is able to access the customers personal information. Instead of requiring, for example, a customer to enter the credit card number of the credit card they would like to use during a transaction, the system may prompt the customer to choose which of their pre-registered credit cards they would like to use. User information may be gathered through a self-registration process or a staff-assisted registration process and may be stored on the processor, a network server of the cable television service provider, or on a financial services institution server, within a customer repository database. Additional required customer enrollment fields can be added based on individual business requirements.

As explained above, the processor may provide a payment gateway to manage the interface with the payment authorization system on a financial services institution server. The payment gateway generates payment authorization requests to the payment engine and then returns the results of the authorization request to the processor. The present invention can support a variety of interfaces to the payment gateway system, including, but not limited to, an HTTP(s) post to a secure website payment system or a Microsoft COM-based interface to an ECS payment engine.

Various preferred embodiments of the invention have been described in fulfillment of the various objects of the invention. It should be recognized that these embodiments are merely illustrative of the principles of the invention. Numerous modifications and adaptations thereof will be readily apparent to those skilled in the art without departing from the spirit and scope of the present invention.

1. A system for providing financial services and facilitating transactions among a user, a merchant and a financial institution comprising:
a user interface and at least one of the following financial services industry systems:
an interactive bill presentment and payment system accessible through the user interface;
a merchant payment processing system administered by the financial institution;
a credit and debit system administered by the financial institution;
a home-banking system;
and a processor for receiving data from the user interface and translating the data into a form usable by at least one of the interactive bill presentment and payment system; the merchant payment processing system; the multi-function financial services system and/or the credit and debit system;
wherein the user interface comprises a television.

2. The system of claim 1 wherein the user interface further comprises a control unit having an input device.

3. The system of claim 1 wherein the television is a cable television and the system further comprises a cable television combiner for providing television services to the television.

4. The system of claim I wherein the processor is located at the site of the television.

5. The system of claim 1 wherein the processor is located at a financial services institution server site.

6. The system of claim I wherein the processor is part of a server maintained by a financial services institution.

7. The system of claim 3 wherein the processor is part of a server maintained by a cable television provider.

8. The system of claim 1 further comprising a merchant site.

9. A method for providing financial services and facilitating transactions among a user, a merchant and a financial institution comprising:
providing a user interface that allows a user to access and at least one of the following financial services industry systems:
an interactive bill presentment and payment system accessible through the user interface;
a merchant payment processing system administered by the financial institution;
a credit and debit system administered by the financial institution;
a home-banking system;
providing a processor for receiving data from the user interface and translating the data into a form usable by at least one of the interactive bill presentment and payment system; the merchant payment processing system; the multi-function financial services system and/or the credit and debit system;
wherein the user interface comprises a television.

10. The method of claim 9 wherein the method further comprises providing cable television service to the user.
